(19) United States
(12) Patent Application Publication
(10) Pub. No.: US 2026/0274223 A1
(43) Pub. Date: Sep. 17, 2026

(54) VEHICLE CONTROL SYSTEM AND SADDLE-TYPE VEHICLE

(71) Applicant: HONDA MOTOR CO., LTD., Tokyo (JP)

(72) Inventors: Masaki NAKAGAWARA, Tokyo (JP); Tsubasa NOSE, Tokyo (JP)

(73) Assignee: HONDA MOTOR CO., LTD., Tokyo (JP)

(21) Appl. No.: 19/469,199

(22) PCT Filed: Mar. 6, 2024
(86) PCT No.: PCT/JP2024/008572

§ 371 Date: Sep. 25, 2025

(30) Foreign Application Priority Data
Mar. 31, 2023 (JP) 2023-057242

(51) Int. Cl. B60T 8/24; B60T 8/17; B60T 8/171; B60T 8/172; B60T 8/1755; B60T 8/58; B60T 13/66; B62J 27/00; B62J 45/415

(52) U.S. Cl. CPC B60T 8/241; B60T 8/1706; B60T 8/171; B60T 8/172; B60T 8/17554; B60T 8/58; B60T 13/662; B62J 27/00; B62J 45/4151; B60T 2220/03; B60T 2250/04

(57) ABSTRACT

A vehicle control system for controlling a saddle-type vehicle including a vehicle body frame, a steering device steerably supported by the vehicle body frame, a front wheel rotatably supported by the steering device, a braking device configured to brake the front wheel according to a braking operation, a first sensor configured to detect a roll angle or a roll angular velocity of the vehicle body frame, and a second sensor configured to detect a predetermined parameter related to a braking force of the braking device, is capable of controlling the braking force, and executes limit control for limiting a decrease in the braking force when it is determined that the vehicle body frame is to be changed to or is changed to an inclined state based on the roll angle or the roll angular velocity and that the braking force decreases based on the parameter detected by the second sensor.

### TECHNICAL FIELD

The present invention relates to a vehicle control system and a saddle-type vehicle.

### BACKGROUND ART

In a saddle-type vehicle such as a motorcycle, it has been desired to decelerate before turning (in other words, before cornering) from a viewpoint of safety. Therefore, an occupant of the saddle-type vehicle operates a braking device by performing a predetermined braking operation such as operating a brake lever before turning, for example, to decelerate the saddle-type vehicle. When the saddle-type vehicle decelerates to some extent, the occupant turns the saddle-type vehicle by inclining (so-called banking) the saddle-type vehicle in a roll direction while decreasing a braking force by the braking device.

For example, the following Patent Literature 1 discloses a technique for controlling an anti-lock braking system (ABS) so as to release a brake force acting on a wheel when a driving operation for increasing an inclined angle of a vehicle body is detected and a magnitude of an inclined angle change rate, which is a temporal change rate of the inclined angle of the vehicle body, is equal to or larger than a determination value.

### CITATION LIST

### Patent Literature

Patent Literature 1: JP2013-244876A

### SUMMARY OF INVENTION

### Technical Problem

However, the above technique in the related art mainly enables a rider having a low skill level (for example, a beginner) to perform cornering more safely, while allowing a rider having a high skill level to perform cornering using his or her own technique, and there is room for improvement from a viewpoint of improving operability of a saddle-type vehicle during cornering (in other words, during turning).

The present invention provides a vehicle control system and a saddle-type vehicle capable of stabilizing steering when the saddle-type vehicle is to be changed to or is changed to an inclined state. It is possible to improve operability of the saddle-type vehicle, thereby further improving safety of traffic and contributing to development of a sustainable transportation system.

### Solution to Problem

An aspect of the present invention is a vehicle control system (ECU, 65, CTR) for controlling a saddle-type vehicle (1), the saddle-type vehicle including a vehicle body frame (10), a steering device (50) steerably supported by the vehicle body frame, a front wheel (FW) as a steering wheel rotatably supported by the steering device, a braking device (61) configured to brake the front wheel according to a braking operation of an occupant, a first sensor (IMU) configured to detect a roll angle or a roll angular velocity of the vehicle body frame, and a second sensor (Se2) configured to detect a predetermined parameter related to a braking force of the braking device,
the vehicle control system
being capable of controlling the braking force of the braking device, and
executing limit control for limiting a decrease in the braking force when it is determined that the vehicle body frame is to be changed to or is changed to an inclined state based on the roll angle or the roll angular velocity detected by the first sensor and it is determined that the braking force decreases based on the parameter detected by the second sensor.

Another aspect of the present invention is a saddle-type vehicle (1) including:
a vehicle body frame (10);
a steering device (50) steerably supported by the vehicle body frame;
a front wheel (FW) as a steering wheel rotatably supported by the steering device;
a braking device (61) configured to brake the front wheel according to a braking operation of an occupant;
a first sensor (IMU) configured to detect a roll angle or a roll angular velocity of the vehicle body frame;
a second sensor (Se2) configured to detect a predetermined parameter related to a braking force of the braking device; and
a vehicle control system (ECU. 65, CTR), in which
the vehicle control system
is configured to control the braking force of the braking device, and
executes limit control for limiting a decrease in the braking force when it is determined that the vehicle body frame is to be changed to or is changed to an inclined state based on the roll angle or the roll angular velocity detected by the first sensor and it is determined that the braking force decreases based on the parameter detected by the second sensor.

### Advantageous Effects of Invention

According to the present invention, it is possible to provide a vehicle control system and a saddle-type vehicle capable of stabilizing steering when the saddle-type vehicle is to be changed to or is changed to an inclined state.

### BRIEF DESCRIPTION OF DRAWINGS

FIG. 1 is a side view of a motorcycle 1 according to one embodiment of the present invention viewed from a left side.

FIG. 2 is a top view of a handle 51 of the motorcycle 1 viewed from above.

FIG. 3 is a block diagram showing an example of a functional configuration related to control of a brake unit 61 capable of braking a front wheel FW of the motorcycle 1.

FIG. 4 is a flowchart showing an example of processing executed by an electronic control unit ECU according to a first embodiment.

FIG. 5 is a diagram showing a control example of a steering torque by processing of step S6 in FIG. 4.

FIG. 6 is a flowchart showing an example of processing executed by the electronic control unit ECU according to a second embodiment.

FIG. 7 is a diagram showing a control example of a brake hydraulic pressure by processing of step S16 in FIG. 6.

FIG. 8 is a flowchart showing an example of processing executed by the electronic control unit ECU according to a third embodiment.

FIG. 9 is a diagram showing a control example of a brake hydraulic pressure by processing of step S26 in FIG. 8.

FIG. 10 is a diagram showing an example of correction performed by the electronic control unit ECU of a modification of the embodiments.

### DESCRIPTION OF EMBODIMENTS

Hereinafter, an embodiment of a vehicle control system and a saddle-type vehicle of the present invention will be described in detail with reference to the drawings. The drawings are viewed in directions of reference numerals. The following embodiment does not limit the invention described in the claims, and not all combinations of features described in the embodiment are essential to the invention. Two or more features among a plurality of features described in the embodiment may be combined freely. Hereinafter, the same or similar elements are denoted by the same or similar reference numerals, and the description thereof may be omitted or simplified as appropriate.

In the present description and the like, in order to simplify and clarify the descriptions, front, rear, left, right, upper, and lower directions are described in accordance with directions viewed from a rider who is an occupant of a motorcycle, and in the drawings, a front side of the motorcycle is represented by Fr, a rear side is represented by Rr, a left side is represented by L, a right side is represented by R, an upper side is represented by U. and a lower side is represented by D.

### First Embodiment

### <Vehicle Body Structure>

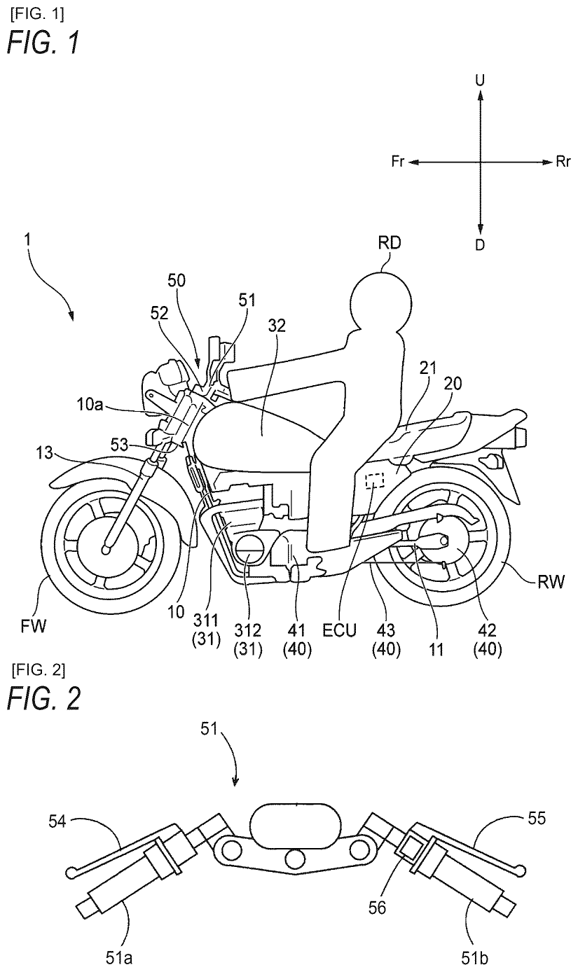

First, a first embodiment of the present invention will be described. As shown in FIG. 1, a motorcycle 1 as an embodiment of the saddle-type vehicle according to the present invention includes a vehicle body frame 10, a cowl member 20 mounted on the vehicle body frame 10 and covering an outer surface of at least a part of the motorcycle 1, a front w % heel FW and a rear wheel RW, and a power unit 31 and a fuel tank 32 mounted on the vehicle body frame 10.

The power unit 31 is disposed between the front wheel FW and the rear wheel RW, and is fixed to the vehicle body frame 10. The power unit 31 includes an engine 311, a clutch unit 312 including a friction clutch (not shown), and a transmission mechanism (not shown). When the friction clutch is in a connection state, the power unit 31 outputs power of the engine 311 from an output shaft via the transmission mechanism. On the other hand, when the friction clutch is in a release state, the power of the engine 311 is not output from the output shaft of the power unit 31.

The fuel tank 32 is disposed above the power unit 31 and is fixed to the vehicle body frame 10. Fuel such as gasoline or diesel fuel is stored in the fuel tank 32. The engine 311 of the power unit 31 generates the power by the fuel stored in the fuel tank 32.

Therefore, the motorcycle 1 according to the present embodiment is a motorcycle in which the engine 311 of the power unit 31 is a prime mover that outputs a driving force for driving the rear wheel RW, and the rear wheel RW is driven by the power of the engine 311 of the power unit 31.

The motorcycle 1 includes a power transmission unit 40 that transmits the power generated by the engine 311 of the power unit 31, which is a power source of the motorcycle 1, to the rear wheel RW.

The power transmission unit 40 includes a drive sprocket 41 that is coupled to the output shaft of the power unit 31 and rotates integrally with the output shaft of the power unit 31, a driven sprocket 42 that rotates coaxially and integrally with the rear wheel RW, and a chain 43 that is wound around the drive sprocket 41 and the driven sprocket 42. Rotational power output from the power unit 31 is transmitted to the driven sprocket 42 via the drive sprocket 41 and the chain 43, and the rear wheel RW is rotationally driven by the rotational power from the power unit 31 which is transmitted to the driven sprocket 42.

The motorcycle 1 includes a pair of left and right swing arms 11 that are disposed on left and right sides of the rear wheel RW and that extend in a front-rear direction. The pair of left and right swing arms 11 support the rear wheel RW at rear ends thereof. Front ends of the pair of left and right swing arms 11 are each pivotally supported by a swing arm pivot (not shown) provided on the vehicle body frame 10. The pair of left and right swing arms 11 are each vertically pivotable about the swing arm pivot as a fulcrum shaft. The pair of left and right swing arms 11 have a function as a framework for coupling the rear wheel RW to the vehicle body frame 10, and also have a function as a part of a shock absorber that absorbs an impact input to the rear wheel RW.

The motorcycle 1 includes a pair of left and right rear suspensions (not shown) that function as a part of the shock absorber that absorbs the impact input to the rear wheel RW. Upper ends of the pair of left and right rear suspensions are coupled to the vehicle body frame 10, and lower ends thereof are respectively coupled to the left and right swing arms 11. Each of the pair of left and right rear suspensions includes, for example, a damper unit having a cylindrical shape, and a coil spring wound so as to surround the damper unit. The impact input to the rear wheel RW is attenuated by the rear suspensions via the swing arms 11.

The motorcycle 1 includes a pair of left and right front forks 13 that are disposed on left and right sides of the front wheel FW. The pair of left and right front forks 13 each have a cylindrical shape extending in an upper-lower direction while being inclined forward toward a lower side, and support the front wheel FW at lower ends thereof. The pair of left and right front forks 13 have a function as a framework for coupling the front wheel FW to the vehicle body frame 10, and also have a function as a shock absorber that absorbs an impact input to the front wheel FW. The impact input to the front wheel FW is attenuated by the front forks 13.

The motorcycle 1 includes a steering unit 50 that is in front of the fuel tank 32 and is pivotably supported with respect to the vehicle body frame 10, and that supports the pair of left and right front forks 13.

More specifically, the steering unit 50 includes a pivotable bar-shaped handle 51 which extends in a left-right direction and which steers the front wheel FW, a top bridge 52 which couples and fixes upper ends of the left and right front forks 13 to each other, and an under bracket 53 which couples and fixes the left and right front forks 13 below the top bridge 52. Therefore, the left and right front forks 13 are fixed to the top bridge 52 and the under bracket 53.

The steering unit 50 includes a stem shaft (not shown) formed integrally with the under bracket 53. The stem shaft is inclined rearward toward an upper side from an upper surface of the under bracket 53 at an intermediate point of the left and right front forks 13 in the left-right direction and extends in the upper-lower direction. A head pipe 10a is provided at a front end of the vehicle body frame 10, the stem shaft is inserted through the head pipe 10a of the vehicle body frame 10, and an upper end thereof is fixed to the top bridge 52 by a fastening member such as a bolt from an upper surface of the top bridge 52.

Therefore, when a rider RD on the motorcycle 1 pivots the handle 51, the steering unit 50 is pivoted integrally about the stem shaft (head pipe 10a of the vehicle body frame 10). At this time, the left and right front forks 13 fixed to the top bridge 52 and the under bracket 53 of the steering unit 50 and the front wheel FW supported by the lower ends of the left and right front forks 13 are also pivoted integrally with the steering unit 50 about the stem shaft (head pipe 10a of the vehicle body frame 10). In this way, the handle 51 steers the front wheel FW. Accordingly, the rider RD on the motorcycle 1 can steer the front wheel FW and turn the motorcycle 1 in the left-right direction by pivoting the handle 51 during traveling.

That is, in the motorcycle 1, the steering unit 50 is a steering device that is supported steerably (in other words, in a turning manner) by the vehicle body frame 10, and the front wheel FW is a steering wheel (in other words, a turning wheel) that is rotatably supported by the steering unit 50.

As shown in FIG. 2, a left handle grip 51a is provided at a left end of the handle 51 extending in the left-right direction. The rider RD on the motorcycle 1 grips the left handle grip 51a with a left hand during traveling. An accelerator grip 51b is provided at a right end of the handle 51 extending in the left-right direction. The rider RD on the motorcycle 1 grips the accelerator grip 51b with a right hand during traveling.

The accelerator grip 51b is an example of a driving instruction input device that receives a driving operation corresponding to a driving instruction from the rider RD. The accelerator grip 51b is pivotable clockwise and counterclockwise as viewed in the left-right direction. For example, as the rider RD pivots the accelerator grip 51b gripped with the right hand counterclockwise as viewed from a right side, a driving operation (driving instruction) for increasing a driving force in the motorcycle 1 is performed, and thus a required driving force Freq for the engine 311 increases. On the other hand, for example, as the rider RD pivots the accelerator grip 51b gripped with the right hand clockwise as viewed from the right side, a driving operation for decreasing the driving force in the motorcycle 1 is performed, and thus the required driving force Freq for the engine 311 decreases.

A clutch lever 54 is provided at a left side portion of the handle 51. The clutch lever 54 is provided to extend in the left-right direction in front of the left handle grip 51a such that the rider RD can operate the clutch lever 54 without separating the left hand from the left handle grip 51a during traveling of the motorcycle 1. When the clutch lever 54 is not operated by the rider RD, the clutch of the power unit 31 is maintained in the connection state. When the clutch lever 54 is operated by the rider RD, the clutch of the power unit 31 is in the release state.

A brake lever 55 as an example of a braking instruction input device that receives a braking operation corresponding to a braking instruction from the rider RD is provided on a right side portion of the handle 51. The brake lever 55 is provided to extend in the left-right direction in front of the accelerator grip 51b such that the rider RD can operate the brake lever 55 without separating the right hand from the accelerator grip 51b during traveling of the motorcycle 1. When the brake lever 55 is operated by the rider RD (that is, when the braking operation is performed), a brake unit provided on the front wheel FW or the rear wheel RW is operated to brake at least one of the front wheel FW and the rear wheel RW.

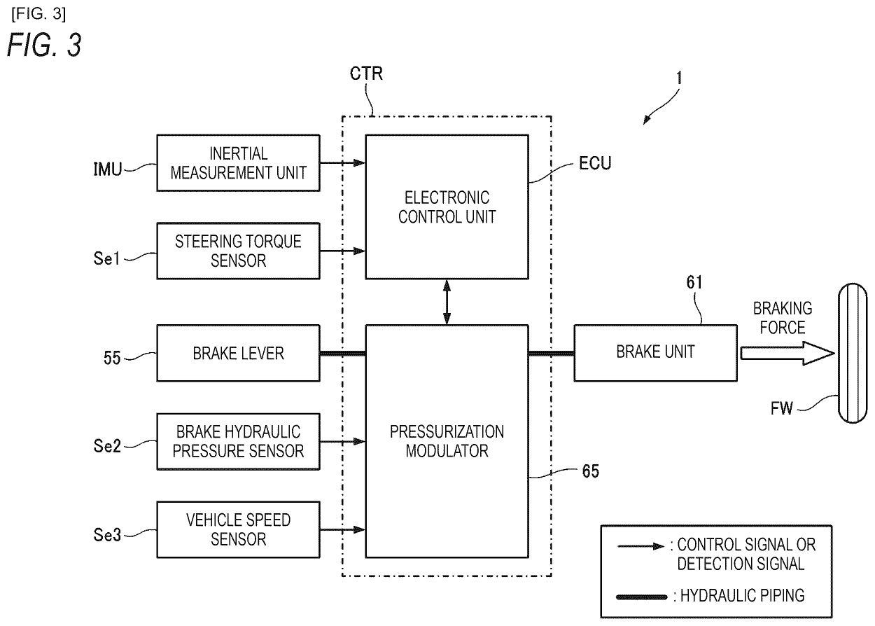

In the present embodiment, when the brake lever 55 is operated by the rider RD, that is, when a braking operation is performed, the front wheel FW is braked by a brake unit 61 (to be described later with reference to FIG. 3) provided on the front wheel FW, but the present invention is not limited thereto. For example, when the braking operation is performed, the front wheel FW may be braked by the brake unit 61, and the rear wheel RW may also be braked by another brake unit provided on the rear wheel RW.

A starter switch 56 is mounted on the right side portion of the handle 51 to be adjacent to a center side of the accelerator grip 51b in a vehicle width direction. In a case where a power supply system of the motorcycle 1 is in an ON state, when the rider RD operates the starter switch 56, the engine 311 starts.

The motorcycle 1 includes an occupant seat 21 on which the rider RD can sit. The occupant seat 21 extends rearward in the front-rear direction from a rear portion of the fuel tank 32, and is disposed at an upper portion of the vehicle body frame 10. The occupant seat 21 is fixed to the vehicle body frame 10. In addition to the rider RD, a passenger may sit on the occupant seat 21 behind the rider RD.

The motorcycle 1 includes an electronic control unit ECU as a computer that integrally controls the entire motorcycle 1. The electronic control unit ECU includes, for example, a processor (for example, a central processing unit (CPU)) that performs various types of calculation, a storage device (for example, a flash memory) that stores various types of information, and an input and output device (interface) that controls input and output of data between inside and outside of the electronic control unit ECU. The electronic control unit ECU is, for example, disposed below the occupant seat 21 and in a space surrounded by the cowl member 20. However, an arrangement position of the electronic control unit ECU is not limited thereto, and the electronic control unit ECU may be disposed at any position in the motorcycle 1.

An ignition switch (not shown) is mounted on the motorcycle 1, and in the motorcycle 1, when the ignition switch is operated by the rider RD, the power supply system of the motorcycle 1 including the electronic control unit ECU is in the ON state, and control of various control targets by the electronic control unit ECU is started.

As an example, the electronic control unit ECU controls the engine 311 such that the required driving force Freq corresponding to the driving operation (in other words, the driving instruction) of the rider RD is output. The output from the engine 311 can be controlled, for example, by controlling an opening degree of a throttle valve (not shown) provided in the engine 311 or fuel injection by a fuel injection device (not shown) provided in the engine 311.

Further, the electronic control unit ECU can also control the brake unit 61 as a braking device capable of braking the front wheel FW according to the braking operation of the rider RD. Hereinafter, a configuration of the motorcycle 1 related to the control of the brake unit 61 by the electronic control unit ECU will be described in detail with reference to FIG. 3.

### <Configuration of Motorcycle Related to Control of Brake Unit>

As shown in FIG. 3, the motorcycle 1 includes, for example, the electronic control unit ECU, the brake unit 61, a pressurization modulator 65, an inertial measurement unit IMU, a steering torque sensor Se1, a brake hydraulic pressure sensor Se2, and a vehicle speed sensor Se3 as the configuration related to the control of the brake unit 61.

The brake unit 61 is, for example, a hydraulic braking device configured to brake the front wheel FW using a hydraulic pressure (hereinafter, also referred to as a “brake hydraulic pressure”) by hydraulic oil referred to as “brake fluid”.

More specifically, in the present embodiment, the brake unit 61 is a hydraulic disc brake, and includes a master cylinder that generates a brake hydraulic pressure according to an operation (that is, a braking operation) on the brake lever 55, a brake disk that is attached to a side of the front wheel FW and rotates integrally with the front wheel FW, a brake caliper that sandwiches the brake disk to apply braking, and the like (all of which are not shown). The brake caliper of the brake unit 61 is provided with a brake pad disposed to sandwich the brake disk, a piston that is pushed out as the brake hydraulic pressure increases to press the brake pad against the brake disk, and the like.

According to such a brake unit 61, the front wheel FW can be braked such that a braking force corresponding to the operation (that is, the braking operation) on the brake lever 55 by the rider RD is generated. That is, in the motorcycle 1, the brake unit 61 is the braking device capable of braking the front wheel FW according to the braking operation of the rider RD who is the occupant of the motorcycle 1. Here, the brake unit 61 is the hydraulic disc brake, but the present invention is not limited thereto. For example, the brake unit 61 may be a hydraulic drum brake.

The pressurization modulator 65 includes, for example, an electric motor, a pump driven by the electric motor, a micro controller unit (MCU) that controls the electric motor according to an instruction from the electronic control unit ECU, and the like, and is configured to control the brake hydraulic pressure of the brake unit 61, that is, the braking force by the brake unit 61 according to the instruction from the electronic control unit ECU. The MCU of the pressurization modulator 65 also transmits detection values of the brake hydraulic pressure sensor Se2, the vehicle speed sensor Se3, and the like to be described later to the electronic control unit ECU.

The pressurization modulator 65 may be an antilock braking system (ABS) modulator that limits locking of the front wheel FW by automatically adjusting the brake hydraulic pressure of the brake unit 61 when it is detected that the front wheel FW is locked or is about to be locked by the braking operation of the rider RD.

In the motorcycle 1 of the present embodiment, the electronic control unit ECU and the pressurization modulator 65 that is capable of controlling the brake unit 61 according to the instruction from the electronic control unit ECU constitute a control system CTR capable of controlling the brake unit 61. The control system CTR is an example of the vehicle control system of the present invention.

In the present embodiment, an example in which the electronic control unit ECU and the pressurization modulator 65 are separate bodies will be described, but the present invention is not limited thereto. For example, the electronic control unit ECU may be provided inside the pressurization modulator 65, and as a specific example, the MCU of the pressurization modulator 65 described above may function as the electronic control unit ECU.

The inertial measurement unit IMU is a sensor configured to detect angular velocities in a pitch direction, a roll direction, and a yaw direction of the vehicle body frame 10 (that is, the motorcycle 1) and accelerations in the front-rear direction, the left-right direction, and the upper-lower direction of the vehicle body frame 10, and is an example of a first sensor in the present invention. Detection values of the angular velocities and the accelerations by the inertial measurement unit IMU are transmitted to the electronic control unit ECU as detection signals.

The steering torque sensor Se1 is a torque sensor configured to detect a steering torque of the steering unit 50 that is the steering device in the motorcycle 1 (hereinafter, also simply referred to as the “steering torque”). Here, the steering torque is, for example, a strength of a rotational force about the stem shaft of the steering unit 50 (head pipe 10a of the vehicle body frame 10). A detection value of the steering torque by the steering torque sensor Se1 is transmitted to the electronic control unit ECU as a detection signal.

The brake hydraulic pressure sensor Se2 is a pressure sensor configured to detect the brake hydraulic pressure of the brake unit 61. As described above, in the brake unit 61, the brake hydraulic pressure corresponding to the operation on the brake lever 55, that is, the braking operation is generated, and the braking force corresponding to the brake hydraulic pressure can be generated. Therefore, the brake hydraulic pressure can be said to be a parameter representing the braking force of the brake unit 61. A detection value of the brake hydraulic pressure by the brake hydraulic pressure sensor Se2 is transmitted to the pressurization modulator 65 as a detection signal, and further transmitted to the electronic control unit ECU via the pressurization modulator 65. The detection value of the brake hydraulic pressure sensor Se2 may be directly transmitted to the electronic control unit ECU.

The vehicle speed sensor Se3 is, for example, a sensor configured to detect a vehicle speed, which is a travel speed of the motorcycle 1, by detecting a rotation speed of the front wheel FW. A detection value of the vehicle speed (or the rotation speed of the front wheel FW) by the vehicle speed sensor Se3 is transmitted to the pressurization modulator 65 as a detection signal, and further transmitted to the electronic control unit ECU via the pressurization modulator 65. The detection value of the vehicle speed sensor Se3 may be directly transmitted to the electronic control unit ECU.

### Example of Processing Executed by Electronic Control Unit of First Embodiment

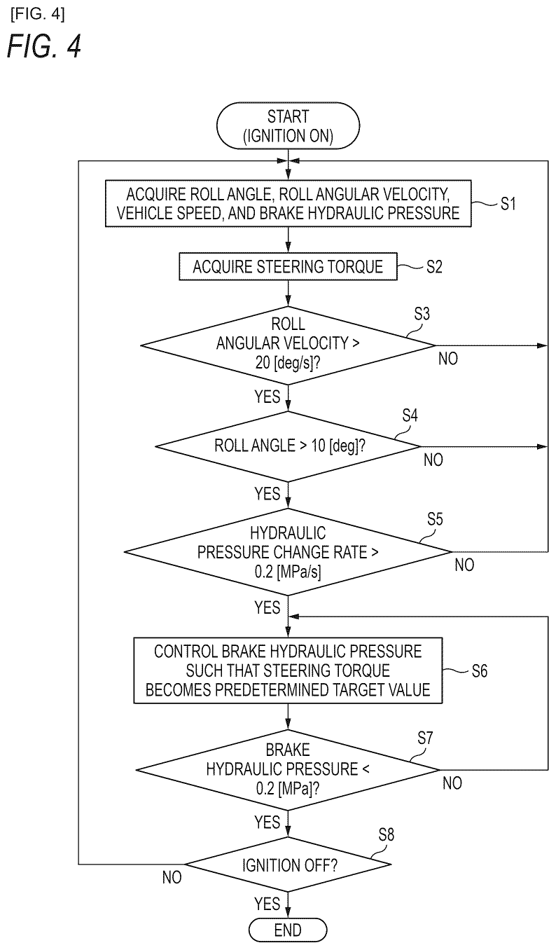

The electronic control unit ECU of the first embodiment executes processing shown in FIG. 4, for example, when the power supply system of the motorcycle 1 is in the ON state (so-called ignition on) by operating the ignition switch.

In the processing shown in FIG. 4, the electronic control unit ECU first acquires a roll angle and a roll angular velocity of the vehicle body frame 10 (that is, the motorcycle 1), a vehicle speed, and a brake hydraulic pressure (step S1). In processing of step S1, for example, the electronic control unit ECU acquires the roll angular velocity from a detection value of the inertial measurement unit IMU, and acquires the roll angle by time-integrating the roll angular velocity. In the processing of step S1, for example, the electronic control unit ECU acquires the vehicle speed from a detection value of the vehicle speed sensor Se3, and acquires the brake hydraulic pressure from a detection value of the brake hydraulic pressure sensor Se2.

Next, the electronic control unit ECU acquires a steering torque from a detection value of the steering torque sensor Se1 (step S2).

Next, the electronic control unit ECU determines whether the roll angular velocity acquired by the processing of step S1 is larger than a preset threshold (here, 20 [deg/s]) (step S3). When the roll angular velocity is larger than the threshold such as 20 [deg/s], there is a high possibility that the motorcycle 1 is leaning (so-called banking). Therefore, when the roll angular velocity is larger than the threshold such as 20 [deg/s], it can be estimated that the vehicle body frame 10 (that is, the motorcycle 1) is changing from an upright state to an inclined state. Here, the upright state may be, for example, a state in which the roll angle of the vehicle body frame 10 is 0 [deg]. The inclined state may be, for example, a state in which an absolute value of the roll angle of the vehicle body frame 10 is larger than 0 [deg].

When the roll angular velocity is equal to or smaller than 20 [deg/s] (step S3; No), the electronic control unit ECU returns to the processing of step S1. On the other hand, when the roll angular velocity is larger than 20 [deg/s](step S3; Yes), the electronic control unit ECU determines whether the roll angle acquired by the processing of step S1 is larger than a preset threshold (here, 10 [deg]) (step S4). When the roll angle is larger than the threshold such as 10 [deg], there is a high possibility that the motorcycle 1 is not in a slightly inclined state due to wobbling but is in an inclined state due to sufficiently leaning accompanying a turn. Therefore, when the roll angle is larger than the threshold such as 10 [deg], it can be estimated that the vehicle body frame 10 is changed to a sufficiently inclined state due to leaning during a turn.

When the roll angle is equal to or smaller than 10 [deg] (step S4; No), the electronic control unit ECU returns to the processing of step S1. On the other hand, when the roll angle is larger than 10 [deg] (step S4; Yes), the electronic control unit ECU determines whether a change rate of the brake hydraulic pressure (hereinafter, also referred to as a “hydraulic pressure change rate”) is larger than a preset threshold (here, 0.2 [MPa/s]) based on the brake hydraulic pressure acquired by the processing of step S1 (step S5).

Here, the hydraulic pressure change rate represents a change amount of the brake hydraulic pressure per unit time, and in the present embodiment, a direction in which the brake hydraulic pressure after the change is reduced more than the brake hydraulic pressure before the change is a positive direction. That is, when the hydraulic pressure change rate is larger than 0 [MPa/s], it can be estimated that a braking operation by the rider RD is changed to decrease a braking force by the brake unit 61 (in other words, brake release is performed). Further, when the hydraulic pressure change rate is larger than the threshold such as 0.2 [MPa/s], it can be estimated that the braking operation by the rider RD is changed to suddenly decrease the braking force by the brake unit 61.

Although details will be described later, the steering torque in the motorcycle 1 depends on a magnitude of a friction force in the left-right direction when a ground contact point of the front wheel FW is desired to be moved. The friction force is proportional to a vertical load of the front wheel FW that changes according to the braking force by the brake unit 61. Therefore, when a state in which the hydraulic pressure change rate is larger than the threshold such as 0.2 [MPa/s] is left, the braking force by the brake unit 61 may suddenly decrease, and accordingly, the steering torque may also suddenly decrease. Such a sudden change in the steering torque is not preferable from a viewpoint of stabilizing steering of the motorcycle 1.

Therefore, when the hydraulic pressure change rate is larger than 0.2 [MPa/s] (step S5; Yes), the electronic control unit ECU controls the brake hydraulic pressure of the brake unit 61 such that the steering torque becomes a predetermined target value (step S6). Accordingly, it is possible to limit the sudden change in the steering torque and stabilize the steering of the motorcycle 1. On the other hand, when the hydraulic pressure change rate is equal to or smaller than 0.2 [MPa/s] (step S5; No), the electronic control unit ECU returns to the processing of step S1.

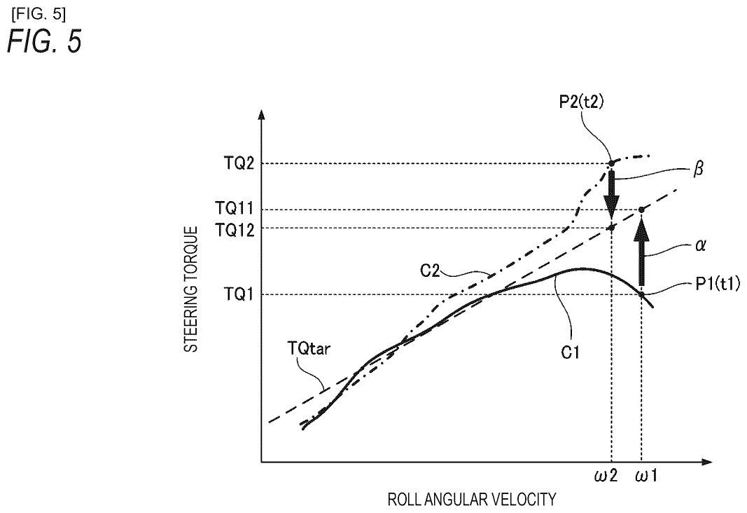

In processing of step S6, the electronic control unit ECU, for example, performs feedback control of the brake hydraulic pressure via the pressurization modulator 65 while referring to the steering torque detected by the steering torque sensor Se1, such that the steering torque becomes the predetermined target value. In this way, by indirectly controlling the steering torque via the brake hydraulic pressure, that is, the braking force by the brake unit 61, it is possible to control the steering torque without providing, in the motorcycle 1, a motor or the like for directly controlling the steering torque. A specific control example of the steering torque by the processing of step S6 will be described later with reference to FIG. 5.

Next, the electronic control unit ECU determines whether the brake hydraulic pressure is smaller than a preset threshold (here, 0.2 [MPa])(step S7). When the brake hydraulic pressure is not smaller than 0.2 [MPa] (step S7; No), the electronic control unit ECU repeats the processing of step S6 until the brake hydraulic pressure is smaller than 0.2 [MPa]. Accordingly, the brake hydraulic pressure, that is, the braking force by the brake unit 61 gradually decreases. That is, the braking force by the brake unit 61 can be weakened according to an intention of the rider RD who performs the brake release.

When the brake hydraulic pressure is smaller than 0.2 [MPa] (step S7; Yes), the electronic control unit ECU ends the processing of step S6 and determines whether the power supply system of the motorcycle 1 is in an OFF state (so-called ignition off) (step S8). When the ignition is not turned off (step S8; No), the electronic control unit ECU returns to the processing of step SL. On the other hand, when the ignition is turned off (step S8; Yes), the electronic control unit ECU ends the processing shown in FIG. 4.

In the example described here, it is determined that the vehicle body frame 10 (that is, the motorcycle 1) is changing or is changed from the upright state to the inclined state, by using both the roll angular velocity and the roll angle, but the present invention is not limited thereto. For example, it may be determined that the vehicle body frame 10 is changing or is changed from the upright state to the inclined state, by using one alone of the roll angle and the roll angular velocity. In other words, one of processing of step S3 and processing of step S4 described above may be omitted.

### Control Example of Steering Torque by Processing of Step S6

A target value TQtar shown in FIG. 5 is an example of the target value of the steering torque used in the processing of step S6. As shown by the target value TQtar, in the present embodiment, the target value of the steering torque corresponding to each roll angular velocity is determined in advance by a manufacturer or the like of the motorcycle 1. Information indicating the target value TQtar is stored in advance in the electronic control unit ECU.

In the processing of step S6, the electronic control unit ECU refers to, for example, the information indicating the target value TQtar, derives a target value corresponding to the roll angular velocity acquired by the processing of step S1, and controls the brake hydraulic pressure of the brake unit 61 such that the steering torque detected by the steering torque sensor Se1 becomes the target value.

For example, when the brake hydraulic pressure of the brake unit 61 increases, the braking force by the brake unit 61 increases, and thus a deceleration of the motorcycle 1 increases. When the deceleration of the motorcycle 1 increases, the vertical load of the front wheel FW also increases due to a balance of a moment in the pitch direction of the motorcycle 1. When the vertical load of the front wheel FW increases, the friction force in the left-right direction when the ground contact point of the front wheel FW is desired to be moved increases, and thus the steering torque also increases. Therefore, the steering torque can be increased by increasing the brake hydraulic pressure of the brake unit 61.

Conversely, when the brake hydraulic pressure of the brake unit 61 decreases, the braking force by the brake unit 61 decreases, and thus the deceleration of the motorcycle 1 decreases. When the deceleration of the motorcycle 1 decreases, the vertical load of the front wheel FW also decreases. When the vertical load of the front wheel FW decreases, the friction force in the left-right direction when the ground contact point of the front wheel FW is desired to be moved decreases, and thus the steering torque also decreases. Therefore, the steering torque can be decreased by decreasing the brake hydraulic pressure of the brake unit 61.

Using such a relationship between the brake hydraulic pressure of the brake unit 61 and the steering torque, the electronic control unit ECU controls the brake hydraulic pressure of the brake unit 61 such that the steering torque detected by the steering torque sensor Se1 becomes the predetermined target value.

For example, a curve C1 shown in FIG. 5 represents a time-series transition of the steering torque and the roll angular velocity of the motorcycle 1 in a first period. A point P1 on the curve C1 represents the steering torque and the roll angular velocity at a time t1 included in the first period, and more specifically, represents that the steering torque at the time t1 is TQ1 and the roll angular velocity is ω1.

Here, TQ1 is smaller than TQ11, which is a target value corresponding to the roll angular velocity of ω1, at the target value TQtar. In such a case, at the time t1, the electronic control unit ECU increases the vertical load of the front wheel FW by increasing the brake hydraulic pressure of the brake unit 61 as indicated by an arrow with a reference numeral a, so that the steering torque becomes TQ11. Accordingly, it is possible to compensate (correct) a change in the steering torque with respect to the roll angular velocity (in other words, a leaning speed of the motorcycle 1).

In this way, control for controlling the brake hydraulic pressure of the brake unit 61 such that the steering torque becomes the predetermined target value corresponding to the roll angular velocity at that time is an example of limit control for limiting a decrease in the braking force by the brake unit 61.

In addition, a curve C2 shown in FIG. 5 represents a time-series transition of the steering torque and the roll angular velocity of the motorcycle 1 in a second period. A point P2 on the curve C2 represents the steering torque and the roll angular velocity at a time t2 included in the second period, and more specifically, represents that the steering torque at the time t2 is TQ2 and the roll angular velocity is ω2.

Here, TQ2 is larger than TQ12, which is a target value corresponding to the roll angular velocity of ω2, at the target value TQtar. In such a case, at the time t2, the electronic control unit ECU decreases the vertical load of the front wheel FW by decreasing the brake hydraulic pressure of the brake unit 61 as indicated by an arrow with a reference numeral β, so that the steering torque becomes TQ12. Accordingly, also in this case, it is possible to compensate the change in the steering torque with respect to the roll angular velocity.

Here, an example in which the brake hydraulic pressure is controlled such that the steering torque decreases when the steering torque is larger than the target value corresponding to the roll angular velocity at that time has been described, but the present invention is not limited thereto. For example, when the steering torque is smaller than the target value corresponding to the roll angular velocity at that time, the brake hydraulic pressure may be increased such that the steering torque becomes the target value, and when the steering torque is larger than the target value, the control of the brake hydraulic pressure for changing the steering torque may not be performed.

As described above, the motorcycle 1, which is the embodiment of the saddle-type vehicle according to the present invention, includes the vehicle body frame 10, the steering unit 50 as the steering device that is supported steerably (in other words, in a turning manner) by the vehicle body frame 10, the front wheel FW as the steering wheel (in other words, the turning wheel) that is rotatably supported by the steering unit 50, the brake unit 61 as the braking device capable of braking the front wheel FW according to the braking operation of the rider RD who is the occupant of the motorcycle 1, the inertial measurement unit IMU that detects the roll angular velocity of the vehicle body frame 10, and the brake hydraulic pressure sensor Se2 that detects the brake hydraulic pressure which is the parameter related to the braking force of the brake unit 61.

The control system CTR including the electronic control unit ECU that controls the motorcycle 1 is configured to control the braking force of the brake unit 61. When the control system CTR (for example, the electronic control unit ECU) determines that the vehicle body frame 10 (that is, the motorcycle 1) is to be changed to or is changed to the inclined state based on the roll angular velocity detected by the inertial measurement unit IMU or the roll angle of the vehicle body frame 10 obtained based on the roll angular velocity (for example, see step S3 and step S4) and determines that the braking force of the brake unit 61 decreases based on the brake hydraulic pressure detected by the brake hydraulic pressure sensor Se2 (for example, see step S5), the control system CTR executes the limit control for limiting the decrease in the braking force of the brake unit 61 (for example, see step S6).

Therefore, in the motorcycle 1, even if an operation of suddenly decreasing the braking force of the brake unit 61 is performed when the vehicle body frame 10 is to be changed to or is changed to the inclined state, the decrease in the braking force of the brake unit 61 can be limited. Accordingly, the vertical load of the front wheel FW can be secured, and thus it is possible to limit the sudden change in the steering torque in the motorcycle 1 and stabilize the steering of the rider RD. Therefore, it is possible to improve operability of the motorcycle 1, thereby further improving safety of traffic and contributing to development of a sustainable transportation system.

The brake unit 61 is the hydraulic braking device capable of braking the front wheel FW by the brake hydraulic pressure, and the electronic control unit ECU is configured to control the braking force of the brake unit 61 by controlling the brake hydraulic pressure of the brake unit 61. When the hydraulic pressure change rate, which is the change amount of the brake hydraulic pressure per unit time, is larger than a predetermined threshold, the electronic control unit ECU determines that the braking force of the brake unit 61 decreases (for example, see step S5), and executes the limit control for limiting the decrease in the braking force of the brake unit 61 (for example, see step S6).

Therefore, in the motorcycle 1, by the limit control, the brake hydraulic pressure is controlled to limit the decrease in the braking force by the brake unit 61, so that the vertical load of the front wheel FW can be secured, and thus it is possible to limit the sudden change in the steering torque in the motorcycle 1, stabilize the steering of the rider RD, and improve the operability in the motorcycle 1. In addition, in the motorcycle 1, by utilizing the brake unit 61 configured in the same manner as the hydraulic braking device that may be provided in a general saddle-type vehicle, it is possible to limit the sudden change in the steering torque in the motorcycle 1 and stabilize the steering of the rider RD. That is, by indirectly controlling the steering torque via such the braking force by the brake unit 61, it is possible to control the steering torque without providing, in the motorcycle 1, a motor or the like for directly controlling the steering torque. Accordingly, it is possible to limit the sudden change in the steering torque in the motorcycle 1 and stabilize the steering of the rider RD while limiting the configuration of the motorcycle 1 from becoming complicated.

In the above limit control, for example, the electronic control unit ECU controls the brake hydraulic pressure of the brake unit 61 such that the steering torque detected by the steering torque sensor Se1 becomes the predetermined target value corresponding to the roll angular velocity at that time. Accordingly, an appropriate steering torque corresponding to the roll angular velocity at that time can be obtained, and thus the steering of the rider RD can be stabilized. For example, when the steering torque is smaller than the target value corresponding to the roll angular velocity at that time, it is possible to increase the steering torque to the target value. Accordingly, the motorcycle 1 is limited from falling down with a small force, and the steering of the rider RD can be stabilized.

In the example described above, when the hydraulic pressure change rate is larger than the predetermined threshold, the electronic control unit ECU determines that the braking force of the brake unit 61 decreases and executes the above limit control, but the present invention is not limited thereto. For example, when the brake hydraulic pressure of the brake unit 61 is smaller than a predetermined threshold, the electronic control unit ECU may determine that the braking force of the brake unit 61 decreases and execute the above limit control.

In the example described above, the inertial measurement unit IMU capable of detecting the roll angular velocity is provided in the motorcycle 1, but the present invention is not limited thereto. For example, instead of or in addition to such the inertial measurement unit IMU, a sensor capable of detecting the roll angle of the vehicle body frame 10 may be provided in the motorcycle 1. The electronic control unit ECU may determine whether the vehicle body frame 10 (that is, the motorcycle 1) is to be changed or is changed from the upright state to the inclined state based on the roll angle detected by the above sensor and/or the roll angular velocity obtained by time-differentiating the roll angle, instead of or in addition to the roll angular velocity detected by the inertial measurement unit IMU.

In the example described above, the brake hydraulic pressure of the brake unit 61 is used as a parameter for determining whether the braking force of the brake unit 61 decreases, but the present invention is not limited thereto. For example, a sensor capable of detecting an operation amount of the brake lever 55 may be provided in the motorcycle 1, and the electronic control unit ECU may determine whether the braking force of the brake unit 61 decreases based on the operation amount detected by the sensor.

In the example described above, the brake unit 61, which is the hydraulic braking device, is used as a braking device to be controlled when controlling the steering torque, but the present invention is not limited thereto. For example, the braking device to be controlled when controlling the steering torque may be a motor (so-called traction motor) capable of outputting a driving force or a regenerative braking force to the front wheel FW. In this case, for example, when the electronic control unit ECU determines that the regenerative braking force by the motor decreases from an accelerator opening degree representing an operation amount of the accelerator grip 51b, the electronic control unit ECU may execute limit control for limiting the decrease in the regenerative braking force of the motor.

### Second Embodiment

Next, a second embodiment of the present invention will be described. Hereinafter, parts different from those of the first embodiment described above will be mainly described, and description of parts common to those of the first embodiment will be appropriately omitted or simplified.

### Example of Processing Executed by Electronic Control Unit of Second Embodiment

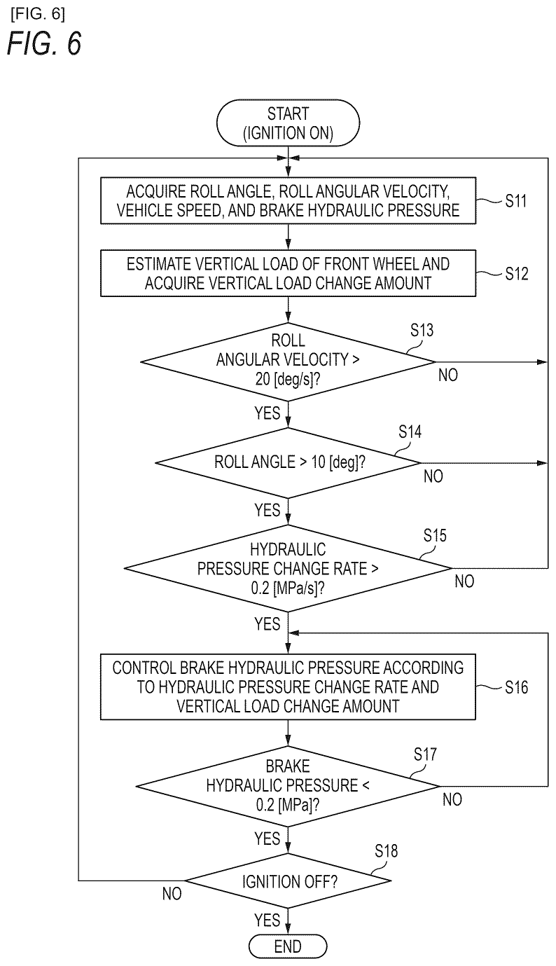

The electronic control unit ECU of the second embodiment executes processing shown in FIG. 6 instead of the processing shown in FIG. 4, for example, when the ignition of the motorcycle 1 is turned on.

In the processing shown in FIG. 6, the electronic control unit ECU first acquires a roll angle and a roll angular velocity of the vehicle body frame 10, a vehicle speed, and a brake hydraulic pressure (step S11). In processing of step S11, the electronic control unit ECU acquires the roll angle, the roll angular velocity, the vehicle speed, and the brake hydraulic pressure, for example, in the same manner as in the processing of step S1 described above.

Next, the electronic control unit ECU estimates a vertical load of the front wheel FW and acquires a vertical load change amount, which is a change amount of the vertical load of the front wheel FW, based on the estimated vertical load of the front wheel FW (step S12). Here, the vertical load change amount may be, for example, a difference between a vertical load of the front wheel FW estimated by processing of a current step S12 and a vertical load of the front wheel FW estimated by processing of a previous step S12. Since an estimation example of the vertical load of the front wheel FW will be described later, the description thereof will be omitted here.

Next, the electronic control unit ECU determines whether the roll angular velocity acquired by the processing of step S11 is larger than 20 [deg/s] in the same manner as in the processing of step S3 described above (step S13).

When the roll angular velocity is equal to or smaller than 20 [deg/s](step S13; No), the electronic control unit ECU returns to the processing of step S11. On the other hand, when the roll angular velocity is larger than 20 [deg/s](step S13; Yes), the electronic control unit ECU determines whether the roll angle acquired by the processing of step S1 is larger than 10 [deg] in the same manner as in the processing of step S4 described above (step S14).

When the roll angle is equal to or smaller than 10 [deg] (step S14; No), the electronic control unit ECU returns to the processing of step S11. On the other hand, when the roll angle is larger than 10 [deg] (step S14; Yes), the electronic control unit ECU determines whether a hydraulic pressure change rate is larger than 0.2 [MPa/s] based on the brake hydraulic pressure acquired by the processing of step S11, in the same manner as in processing of step S5 described above (step S15).

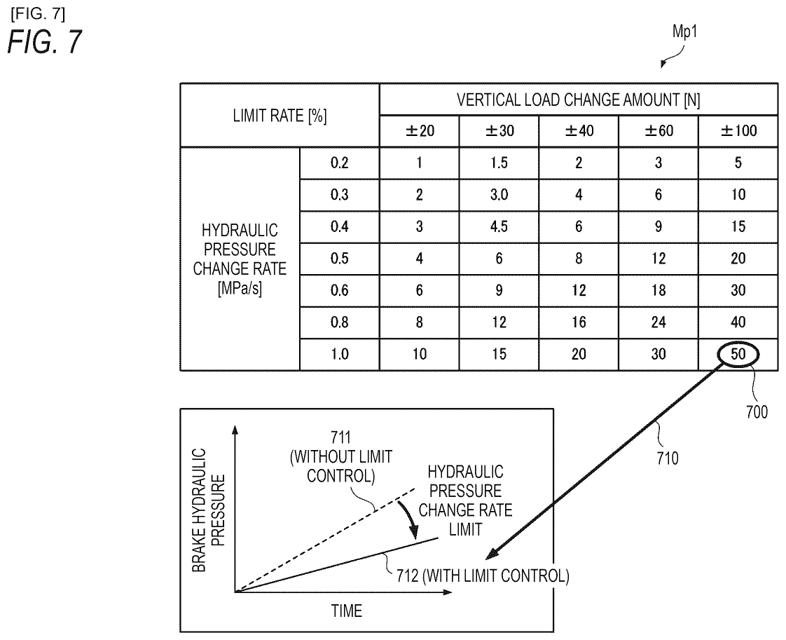

When the hydraulic pressure change rate is equal to or smaller than 0.2 [MPa/s] (step S15; No), the electronic control unit ECU returns to the processing of step S11. On the other hand, when the hydraulic pressure change rate is larger than 0.2 [MPa/s](step S15; Yes), the electronic control unit ECU controls the brake hydraulic pressure of the brake unit 61 according to the hydraulic pressure change rate and the vertical load change amount (step S16). A specific control example of the brake hydraulic pressure by processing of step S16 will be described later with reference to FIG. 7.

Next, the electronic control unit ECU determines whether the brake hydraulic pressure is smaller than 0.2 [MPa] in the same manner as in processing of step S7 described above (step S17). When the brake hydraulic pressure is not smaller than 0.2 [MPa] (step S17; No), the electronic control unit ECU repeats the processing of step S16 until the brake hydraulic pressure is smaller than 0.2 [MPa].

Then, when the brake hydraulic pressure is smaller than 0.2 [MPa](step S17; Yes), the electronic control unit ECU ends the processing of step S16 and determines whether the ignition of the motorcycle 1 is turned off (step S18). When the ignition is not turned off (step S18; No), the electronic control unit ECU returns to the processing of step S1. On the other hand, when the ignition is turned off (step S18; Yes), the electronic control unit ECU ends the processing shown in FIG. 6.

### Estimation Example of Vertical Load of Front Wheel FW

Here, the estimation example of the vertical load of the front wheel FW in processing of step S12 described above will be described.

When a deceleration of the motorcycle 1 (that is, an acceleration in the front-rear direction) is a, a mass of the motorcycle 1 is M, and a braking force with respect to the front wheel FW (that is, a force acting in the front-rear direction) is Ff, a relationship therebetween may be expressed by, for example, the following Equation (1).

$$a = M / Ff \qquad ( 1 )$$

In addition, when a vertical load of the front wheel FW is dFf, a height in a vertical direction from a ground to a center of gravity of the motorcycle 1 (hereinafter, also referred to as a “center of gravity height”) is H, and a wheel base between the front wheel FW and the rear wheel RW is L, a relationship therebetween may be expressed by, for example, the following Equation (2) using the above a and M from a balance of a moment in a pitch direction of the motorcycle 1.

$$dFf \times L = M \times a \times H \qquad ( 2 )$$

M, which is the mass of the motorcycle 1, H, which is the center of gravity height, and L, which is the wheel base, are all known values. In addition, a, which is the deceleration of the motorcycle 1, can be acquired based on a vehicle speed detected by the vehicle speed sensor Se3 or an acceleration in the front-rear direction detected by the inertial measurement unit IMU. Therefore, the electronic control unit ECU can estimate the vertical load of the front wheel FW based on, for example, the mass M, the center of gravity height H, and the wheel base L that are set in advance, the deceleration a acquired from a detection value of the vehicle speed sensor Se3 or the inertial measurement unit IMU, and the above Equation (2).

### Control Example of Brake Hydraulic Pressure by Processing of Step S16

A limit rate map Mp1 shown in FIG. 7 is an example of a map (information) that defines a limit rate for each combination of the vertical load change amount that is the change amount of the vertical load of the front wheel FW and the hydraulic pressure change rate that is a change amount of the brake hydraulic pressure per unit time. In the present embodiment, instead of the information indicating the target value TQtar described above, the limit rate map Mp1 is stored in advance in the electronic control unit ECU.

In the limit rate map Mp1, “±20 [N]” as the vertical load change amount means that an absolute value of the vertical load change amount is equal to or smaller than 20 [N], for example. In addition, “±30 [N]” as the vertical load change amount means that the absolute value of the vertical load change amount is larger than 20 [N] and equal to or smaller than 30 [N], for example.

Similarly, the vertical load change amount of “±40 [N]” means that the absolute value of the vertical load change amount is larger than 30 [N] and equal to or smaller than 40 [N], “±60 [N]” means that the absolute value of the vertical load change amount is larger than 40 [N] and equal to or smaller than 60 [N], and “±100 [N]” means that the absolute value of the vertical load change amount is larger than 60 [N] and equal to or smaller than 100 [N]. In the motorcycle 1, usually, the absolute value of the vertical load change amount does not exceed 100 [N].

In the limit rate map Mp1, “0.2 [MPa/s]” as the hydraulic pressure change rate means that an absolute value of the hydraulic pressure change rate is equal to or larger than 0.2 [MPa/s] and less than 0.3 [MPa/s], for example. In addition, “0.3 [MPa/s]” as the hydraulic pressure change rate means that the absolute value of the hydraulic pressure change rate is equal to or larger than 0.3 [MPa/s] and less than 0.4 [MPa/s], for example.

Similarly, the hydraulic pressure change rate of “0.4 [MPa/s]” means that the absolute value of the hydraulic pressure change rate is equal to or larger than 0.4 [MPa/s] and less than 0.5 [MPa/s], “0.5 [MPa/s]” means that the absolute value of the hydraulic pressure change rate is equal to or larger than 0.5 [MPa/s] and less than 0.6 [MPa/s], “0.6 [MPa/s]” means that the absolute value of the hydraulic pressure change rate is equal to or larger than 0.6 [MPa/s] and less than 0.8 [MPa/s], “0.8 [MPa/s]” means that the absolute value of the hydraulic pressure change rate is equal to or larger than 0.8 [MPa/s] and less than 1.0 [MPa/s], and “1.0 [MPa/s]” means that the absolute value of the hydraulic pressure change rate is equal to or larger than 1.0 [MPa/s].

As shown in FIG. 7, in the limit rate map Mp1, the limit rate corresponding to each vertical load change amount is defined such that the limit rate increases as the vertical load change amount increases. In addition, as shown in FIG. 7, in the limit rate map Mp1, the limit rate corresponding to each hydraulic pressure change rate is defined such that the limit rate increases as the hydraulic pressure change rate increases. The values of the vertical load change amount, the hydraulic pressure change rate, and the limit rate shown in FIG. 7 are merely examples, and are not limited thereto. That is, the values of the vertical load change amount, the hydraulic pressure change rate, and the limit rate in the limit rate map Mp1 can be appropriately determined by a manufacturer of the motorcycle 1.

In the processing of step S16, the electronic control unit ECU refers to the limit rate map Mp1 to derive the limit rate corresponding to the vertical load change amount acquired by the processing of step S12 and the hydraulic pressure change rate obtained based on the brake hydraulic pressure acquired by the processing of step S11. For example, when the acquired vertical load change amount is 100 [N] and the acquired hydraulic pressure change rate is 1.0 [MPa/s], the electronic control unit ECU derives a limit rate of 50 [%] as indicated by an ellipse denoted by a reference numeral 700.

Then, the electronic control unit ECU controls the brake hydraulic pressure of the brake unit 61 using the derived limit rate. More specifically, at this time, the electronic control unit ECU derives a corrected hydraulic pressure change rate by multiplying the derived limit rate by the hydraulic pressure change rate when the processing of step S16 is not performed (in other words, when limit control is not performed).

For example, when the limit rate of 50 [%] is derived, the electronic control unit ECU derives, as a corrected hydraulic pressure change rate 712, a value obtained by multiplying a slope (change rate) of a hydraulic pressure change rate 711 in a case where the limit control is not performed by 0.5, as indicated by an arrow denoted by a reference numeral 710, the hydraulic pressure change rate 711, and the corrected hydraulic pressure change rate 712. Then, the electronic control unit ECU controls the brake hydraulic pressure of the brake unit 61 such that an actual hydraulic pressure change rate becomes the corrected hydraulic pressure change rate 712. Accordingly, the hydraulic pressure change rate can be decreased as compared with the case where the limit control is not performed. In this way, control for controlling the brake hydraulic pressure of the brake unit 61 such that the hydraulic pressure change rate decreases is another example of the limit control for limiting the decrease in the braking force by the brake unit 61.

As described above, according to the present embodiment, even if an operation of decreasing a braking force of the brake unit 61 is performed when the vehicle body frame 10 is to be changed or is changed from an upright state to an inclined state, a decrease in the braking force of the brake unit 61 can be limited, similarly to the first embodiment described above. Accordingly, the vertical load of the front wheel FW can be secured, and thus it is possible to limit a sudden change in a steering torque in the motorcycle 1 and stabilize steering of the rider RD. Therefore, it is possible to improve operability of the motorcycle 1, thereby further improving safety of traffic and contributing to development of a sustainable transportation system.

Further, according to the present embodiment, it is possible to appropriately control the braking force of the brake unit 61 without using a detection value of the steering torque sensor Se1. Therefore, in the motorcycle 1 of the present embodiment, the steering torque sensor Se1 may be omitted from the configuration shown in FIG. 3, and the configuration of the motorcycle 1 can be simplified.

In addition, in the limit control, for example, the electronic control unit ECU of the present embodiment can control the brake hydraulic pressure such that the hydraulic pressure change rate decreases as the hydraulic pressure change rate increases by referring to the limit rate map Mp1. Accordingly, it is possible to appropriately control the brake hydraulic pressure according to the hydraulic pressure change rate when the operation of decreasing the braking force of the brake unit 61 is performed. For example, in a case where the hydraulic pressure change rate when the operation of decreasing the braking force of the brake unit 61 is performed is relatively large, the brake hydraulic pressure is controlled such that the hydraulic pressure change rate decreases, the braking force of the brake unit 61 and the steering torque in the motorcycle 1 are limited from suddenly changing, and the steering of the rider RD can be stabilized. On the other hand, in a case where the hydraulic pressure change rate when the operation of decreasing the braking force of the brake unit 61 is performed is relatively small, it is possible to limit the brake hydraulic pressure from being excessively controlled and to prevent the rider RD from feeling discomfort or displeasure due to excessive control intervention.

Further, the electronic control unit ECU of the present embodiment is configured to estimate the vertical load of the front wheel FW. In the limit control, for example, the electronic control unit ECU can control the brake hydraulic pressure such that the hydraulic pressure change rate decreases as an estimated change amount of the vertical load of the front wheel FW (that is, the vertical load change amount) increases by referring to the limit rate map Mp1. Accordingly, it is possible to appropriately control the brake hydraulic pressure according to the change amount of the vertical load of the front wheel FW due to the operation of decreasing the braking force of the brake unit 61. For example, when the change amount of the vertical load of the front wheel FW due to the operation of decreasing the braking force of the brake unit 61 is relatively large, the brake hydraulic pressure is controlled such that the hydraulic pressure change rate decreases, the braking force of the brake unit 61 and the steering torque in the motorcycle 1 are limited from suddenly changing, and the steering of the rider RD can be stabilized. On the other hand, when the change amount of the vertical load of the front wheel FW due to the operation of decreasing the braking force of the brake unit 61 is relatively small, it is possible to limit the brake hydraulic pressure from being excessively controlled and to prevent the rider RD from feeling discomfort or displeasure due to excessive control intervention.

### Third Embodiment

Next, a third embodiment of the present invention will be described. Hereinafter, parts different from those of the first embodiment or the second embodiment described above will be mainly described, and description of parts common to those of the first embodiment or the second embodiment will be appropriately omitted or simplified.

### Example of Processing Executed by Electronic Control Unit of Third Embodiment

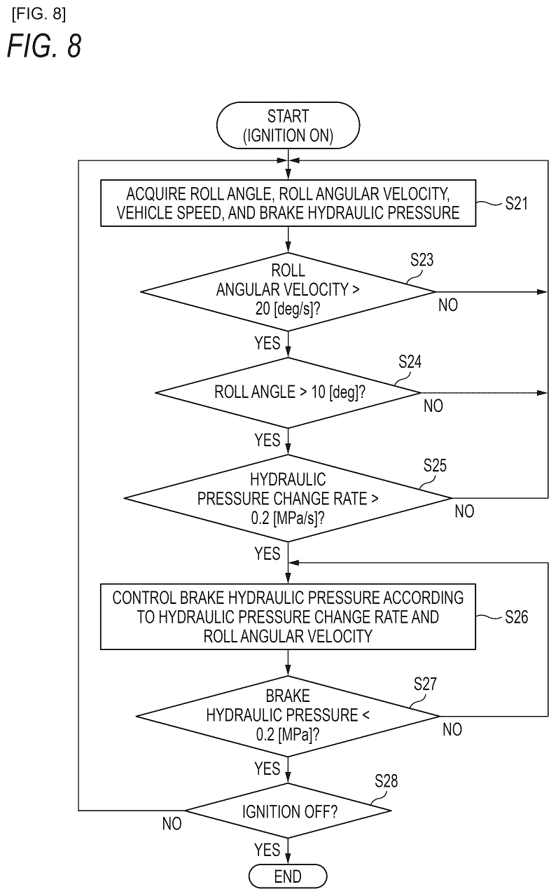

The electronic control unit ECU of the third embodiment executes processing shown in FIG. 8 instead of the processing shown in FIG. 4 or 6, for example, when the ignition of the motorcycle 1 is turned on.

In the processing shown in FIG. 8, the electronic control unit ECU first acquires a roll angle and a roll angular velocity of the vehicle body frame 10, a vehicle speed, and a brake hydraulic pressure (step S21). In processing of step S21, the electronic control unit ECU acquires the roll angle, the roll angular velocity, the vehicle speed, and the brake hydraulic pressure, for example, in the same manner as in the processing of step S1 described above.

Next, the electronic control unit ECU determines whether the roll angular velocity acquired by the processing of step S11 is larger than 20 [deg/s] in the same manner as in the processing of step S3 described above (step S23).

When the roll angular velocity is equal to or smaller than 20 [deg/s](step S23; No), the electronic control unit ECU returns to the processing of step S21. On the other hand, when the roll angular velocity is larger than 20 [deg/s](step S23; Yes), the electronic control unit ECU determines whether the roll angle acquired by the processing of step S21 is larger than 10 [deg] in the same manner as in the processing of step S4 described above (step S24).

When the roll angle is equal to or smaller than 10 [deg](step S24; No), the electronic control unit ECU returns to the processing of step S21. On the other hand, when the roll angle is larger than 10 [deg](step S24; Yes), the electronic control unit ECU determines whether a hydraulic pressure change rate is larger than 0.2 [MPa/s] based on the brake hydraulic pressure acquired by the processing of step S21, in the same manner as in the processing of step S5 described above (step S25).

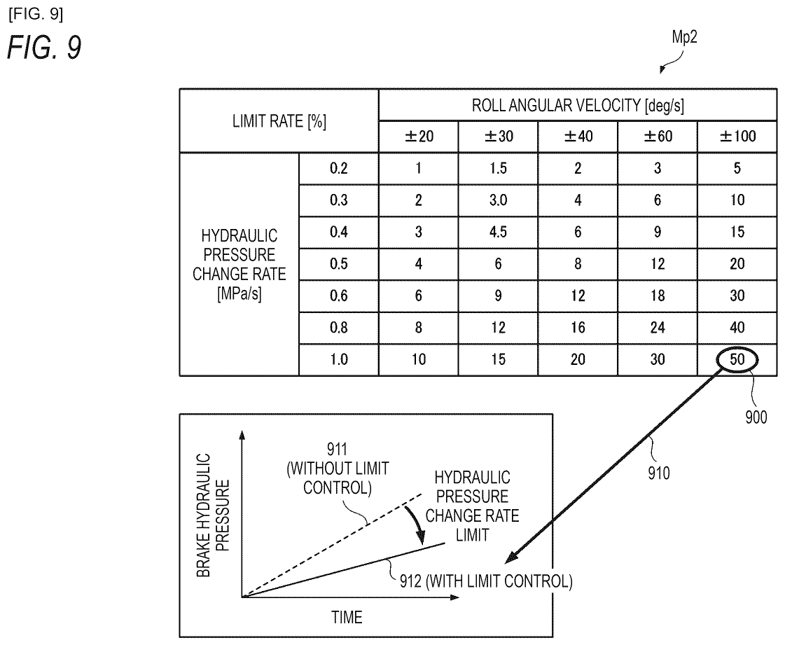

When the hydraulic pressure change rate is equal to or smaller than 0.2 [MPa/s](step S25; No), the electronic control unit ECU returns to the processing of step S21. On the other hand, when the hydraulic pressure change rate is larger than 0.2 [MPa/s](step S25; Yes), the electronic control unit ECU controls the brake hydraulic pressure of the brake unit 61 according to the hydraulic pressure change rate and the roll angular velocity (step S26). A specific control example of the brake hydraulic pressure by processing of step S26 will be described later with reference to FIG. 9.

Next, the electronic control unit ECU determines whether the brake hydraulic pressure is smaller than 0.2 [MPa] in the same manner as in the processing of step S7 described above (step S27). When the brake hydraulic pressure is not smaller than 0.2 [MPa](step S27: No), the electronic control unit ECU repeats the processing of step S26 until the brake hydraulic pressure is smaller than 0.2 [MPa].

Then, when the brake hydraulic pressure is smaller than 0.2 [MPa](step S27; Yes), the electronic control unit ECU ends the processing of step S26 and determines whether the ignition of the motorcycle 1 is turned off (step S28). When the ignition is not turned off (step S28; No), the electronic control unit ECU returns to the processing of step S21. On the other hand, when the ignition is turned off (step S28; Yes), the electronic control unit ECU ends the processing shown in FIG. 8.

### Control Example of Brake Hydraulic Pressure by Processing of Step S26

A limit rate map Mp2 shown in FIG. 9 is an example of a map that defines a limit rate for each combination of the roll angular velocity and the hydraulic pressure change rate that is a change amount of the brake hydraulic pressure per unit time. In the present embodiment, instead of the information indicating the target value TQtar or the limit rate map Mp1 described above, the limit rate map Mp2 is stored in advance in the electronic control unit ECU.

In the limit rate map Mp2, “±20 [deg/s]” as the roll angular velocity means that an absolute value of the roll angular velocity is equal to or smaller than 20 [deg/s], for example. In addition, “±30 [deg/s]” as the roll angular velocity means that the absolute value of the roll angular velocity is larger than 20 [deg/s] and equal to or smaller than 30 [deg/s], for example.

Similarly, the roll angular velocity of “±40 [deg/s]” means that the absolute value of the roll angular velocity is larger than 30 [deg/s] and equal to or smaller than 40 [deg/s], “±60 [deg/s]” means that the absolute value of the roll angular velocity is larger than 40 [deg/s] and equal to or smaller than 60 [deg/s], and “±100 [deg/s]” means that the absolute value of the roll angular velocity is larger than 60 [deg/s] and equal to or smaller than 100 [deg/s]. In the motorcycle 1, usually, the absolute value of the roll angular velocity does not exceed 100 [deg/s].

Since meaning of each hydraulic pressure change rate in the limit rate map Mp2 is the same as each hydraulic pressure change rate in the limit rate map Mp1, the description thereof will be omitted here.

As shown in FIG. 9, in the limit rate map Mp2, the limit rate corresponding to each roll angular velocity is defined such that the limit rate increases as the roll angular velocity increases. In addition, as shown in FIG. 9, in the limit rate map Mp2, the limit rate corresponding to each hydraulic pressure change rate is defined such that the limit rate increases as the hydraulic pressure change rate increases. The values of the roll angular velocity, the hydraulic pressure change rate, and the limit rate shown in FIG. 9 are merely examples, and are not limited thereto. That is, the values of the roll angular velocity, the hydraulic pressure change rate, and the limit rate in the limit rate map Mp2 can be appropriately determined by a manufacturer of the motorcycle 1.

In the processing of step S26, the electronic control unit ECU refers to the limit rate map Mp2 to derive the limit rate corresponding to the roll angular velocity acquired by the processing of step S21 and the hydraulic pressure change rate obtained based on the brake hydraulic pressure acquired by the processing of step S11. For example, when the acquired roll angular velocity is 100 [deg/s] and the acquired hydraulic pressure change rate is 1.0 [MPa/s], the electronic control unit ECU derives a limit rate of 50 [%] as indicated by an ellipse denoted by a reference numeral 900.

Then, the electronic control unit ECU controls the brake hydraulic pressure of the brake unit 61 using the derived limit rate in the same manner as in the processing of step S16 described above. Accordingly, for example, when the limit rate of 50 [%] is derived, the electronic control unit ECU derives, as a corrected hydraulic pressure change rate 912, a value obtained by multiplying a slope (change rate) of a hydraulic pressure change rate 911 in a case where limit control is not performed by 0.5, as indicated by an arrow denoted by a reference numeral 910, the hydraulic pressure change rate 911, and the corrected hydraulic pressure change rate 912. Then, the electronic control unit ECU controls the brake hydraulic pressure of the brake unit 61 such that an actual hydraulic pressure change rate becomes the corrected hydraulic pressure change rate 912. Accordingly, the hydraulic pressure change rate can be decreased as compared with the case where the limit control is not performed in the same manner as in the processing of step S16 described above.

As described above, according to the present embodiment, even if an operation of decreasing a braking force of the brake unit 61 is performed when the vehicle body frame 10 is to be changed or is changed from an upright state to an inclined state, a decrease in the braking force of the brake unit 61 can be limited, similarly to the first embodiment and the second embodiment described above. Accordingly, a vertical load of the front wheel FW can be secured, and thus it is possible to limit a sudden change in a steering torque in the motorcycle 1 and stabilize steering of the rider RD. Therefore, it is possible to improve operability of the motorcycle 1, thereby further improving safety of traffic and contributing to development of a sustainable transportation system.

Further, according to the present embodiment, it is possible to appropriately control the braking force of the brake unit 61 without using a detection value of the steering torque sensor Se1. Therefore, in the motorcycle 1 of the present embodiment, the steering torque sensor Se1 may be omitted from the configuration shown in FIG. 3, and the configuration of the motorcycle 1 can be simplified. According to the present embodiment, it is not necessary to estimate the vertical load of the front wheel FW, and a processing load of the electronic control unit ECU can be reduced.

In addition, in the limit control, for example, the electronic control unit ECU of the present embodiment can control the brake hydraulic pressure such that the hydraulic pressure change rate decreases as the hydraulic pressure change rate increases, similarly to the electronic control unit ECU of the second embodiment, by referring to the limit rate map Mp2. Accordingly, it is possible to appropriately control the brake hydraulic pressure according to the hydraulic pressure change rate when the operation of decreasing the braking force of the brake unit 61 is performed.

Further, in the limit control, for example, the electronic control unit ECU of the present embodiment can control the brake hydraulic pressure such that the hydraulic pressure change rate decreases as the roll angular velocity increases by referring to the limit rate map Mp2. Accordingly, it is possible to appropriately control the brake hydraulic pressure according to the roll angular velocity when the operation of decreasing the braking force of the brake unit 61 is performed. For example, in a case where the roll angular velocity when the operation of decreasing the braking force of the brake unit 61 is performed is relatively large, the brake hydraulic pressure is controlled such that the hydraulic pressure change rate decreases, the braking force of the brake unit 61 and the steering torque in the motorcycle 1 are limited from suddenly changing, and the steering of the rider RD can be stabilized. On the other hand, in a case where the roll angular velocity when the operation of decreasing the braking force of the brake unit 61 is performed is relatively small, it is possible to limit the brake hydraulic pressure from being excessively controlled and to prevent the rider RD from feeling discomfort or displeasure due to excessive control intervention.

### <Modification of Embodiments>

Next, a modification of the embodiments described above will be described. Hereinafter, parts different from those of the embodiments described above will be mainly described, and description of parts common to those of the embodiments will be appropriately omitted or simplified.

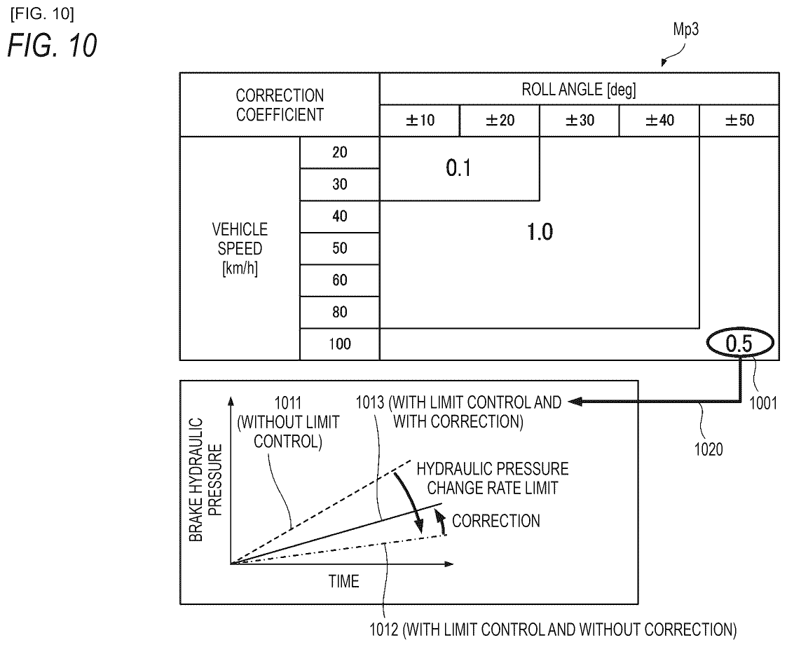

A correction coefficient map Mp3 shown in FIG. 10 is an example of a map defining a correction coefficient for each combination of a roll angle and a vehicle speed. In the present example, the correction coefficient map Mp3 is stored in advance in the electronic control unit ECU.

In the correction coefficient map Mp3, “±10 [deg]” as the roll angle means that an absolute value of the roll angle is equal to or smaller than 10 [deg], for example. In addition, “+20 [deg]” as the roll angle means that the absolute value of the roll angle is larger than 10 [deg] and equal to or smaller than 20 [deg], for example.

Similarly, the roll angle of “±30 [deg]” means that the absolute value of the roll angle is larger than 20 [deg] and equal to or smaller than 30 [deg], “±40 [deg/s]” means that the absolute value of the roll angle is larger than 30 [deg] and equal to or smaller than 40 [deg], and “±50 [deg]” means that the absolute value of the roll angle is larger than 40 [deg].

In the correction coefficient map Mp3, “20 [km/h]” as the vehicle speed means that the vehicle speed is equal to or lower than 20 [km/h], for example. In addition, “30 [km/h]” as the vehicle speed means that the vehicle speed is higher than 20 [km/h] and equal to or lower than 30 [km/h], for example.

Similarly, the vehicle speed of “40 km/h” means that the vehicle speed is higher than 30 km/h and equal to or lower than 40 km/h, “50 km/h” means that the vehicle speed is higher than 40 km/h and equal to or lower than 50 km/h. “60 km/h” means that the vehicle speed is higher than 50 km/h and equal to or lower than 60 km/h, “80 km/h” means that the vehicle speed is higher than 60 km/h and equal to or lower than 80 km/h, and “100 km/h” means that the vehicle speed is higher than 80 km/h.

As shown in FIG. 10, in the correction coefficient map Mp3, a correction coefficient of 0.1 smaller than 1 is set for each of combinations of the roll angle of “±10 [deg]” and the vehicle speed of “20 [km/h]”, the roll angle of “±10 [deg]” and the vehicle speed of “30 [km/h]”, the roll angle of “±20 [deg]” and the vehicle speed of “20 [km/h]”, and the roll angle of “±20 [deg]” and the vehicle speed of “30 [km/h]”. Similarly, in the correction coefficient map Mp3, a correction coefficient of 0.5 smaller than 1 is set for each of a combination including the roll angle of “±50 [deg]” and a combination including the vehicle speed of “100 [km/h]”. The values of the roll angle, the vehicle speed, and the correction coefficient shown in FIG. 10 are merely examples, and are not limited thereto. That is, the values of the roll angle, the vehicle speed, and the correction coefficient in the correction coefficient map Mp3 can be appropriately determined by a manufacturer of the motorcycle 1.

In the present example, the electronic control unit ECU corrects a limit amount by limit control with the correction coefficient corresponding to the roll angle and the vehicle speed. For example, when the acquired roll angle is 50 [deg] and the acquired vehicle speed is 100 [km/h], the electronic control unit ECU refers to the correction coefficient map Mp3 and derives a correction coefficient of 0.5 as indicated by an ellipse denoted by a reference numeral 1001.

Then, the electronic control unit ECU uses the derived correction coefficient to control the limit amount by the limit control, that is, a brake hydraulic pressure of the brake unit 61. More specifically, in FIG. 10, a hydraulic pressure change rate 1011 represents a hydraulic pressure change rate w % ben the limit control is not performed. A hydraulic pressure change rate 1012 represents a hydraulic pressure change rate when the limit control is performed and the correction is not performed. A hydraulic pressure change rate 1013 represents a hydraulic pressure change rate when the limit control is performed and the correction is performed. Here, the hydraulic pressure change rate 1013 has, for example, a slope (change rate) of 0.5 times the hydraulic pressure change rate 1012 when the limit control is performed and the correction is not performed.

For example, when the correction coefficient of 0.5 is derived as described above, the electronic control unit ECU controls the brake hydraulic pressure of the brake unit 61 so as to be the hydraulic pressure change rate 1013 in a case where the limit control is performed and the correction is performed, which is obtained by multiplying, by 0.5, a slope of the hydraulic pressure change rate 1012 in a case where the limit control is performed and the correction is not performed, as indicated by an arrow denoted by a reference numeral 1020.

Although not shown, for example, when the correction coefficient of 0.1 is derived, the electronic control unit ECU controls the brake hydraulic pressure of the brake unit 61 so as to be a hydraulic pressure change rate obtained by multiplying, by 0.1, the slope of the hydraulic pressure change rate 1012 in the case where the limit control is performed and the correction is not performed.

On the other hand, when the correction coefficient of 1.0 is derived, the electronic control unit ECU controls the brake hydraulic pressure of the brake unit 61 so as to be the hydraulic pressure change rate 1012 in the case where the limit control is performed and the correction is not performed.

To summarize the above, for example, in accordance with the correction coefficient map Mp3, when the absolute value of the roll angle is equal to or smaller than a first predetermined value of 20 [deg] and the vehicle speed is equal to or smaller than a second predetermined value of 30 [km/h], the electronic control unit ECU of the present example may reduce limit of a braking force by the limit control as compared with a case where the roll angle is larger than 20 [deg](that is, the first predetermined value) or the vehicle speed is higher than 30 [km/h] (that is, the second predetermined value).

That is, when both the roll angle and the vehicle speed are small to some extent, it can be regarded as substantially the same as straight traveling (for example, lane change), and thus it is assumed that the rider RD can steer the motorcycle 1 with a sufficient margin. Therefore, as described above, in such a case, by reducing the limit of the braking force by the limit control, the electronic control unit ECU can limit the brake hydraulic pressure from being excessively controlled and to prevent the rider RD from feeling discomfort or displeasure due to excessive control intervention. In such a case, the electronic control unit ECU may not execute the limit control itself.

For example, in accordance with the correction coefficient map Mp3, when the absolute value of the roll angle is larger than a third predetermined value of 40 [deg], and the vehicle speed is larger than a fourth predetermined value of 100 [km/h], the electronic control unit ECU of the present example may reduce the limit of the braking force by the limit control as compared with a case where the roll angle is equal to or smaller than the third predetermined value or the vehicle speed is equal to or smaller than the fourth predetermined value.

That is, when both the roll angle and the vehicle speed are large to some extent, it is assumed that a steering torque is secured to some extent by an inertial force of the front wheel FW. Therefore, as described above, in such a case, by reducing the limit of the braking force by the limit control, the electronic control unit ECU can limit the brake hydraulic pressure from being excessively controlled and to prevent the rider RD from feeling discomfort or displeasure due to excessive control intervention. In addition, when both the roll angle and the vehicle speed are large to some extent, there is a possibility that the rider RD has high skill or the motorcycle 1 is traveling on a circuit or the like. Therefore, in such a case, by reducing the limit of the braking force by the limit control, the electronic control unit ECU can limit the brake hydraulic pressure from being excessively controlled and to prevent the rider RD from feeling discomfort or displeasure due to excessive control intervention. In such a case, the electronic control unit ECU may not execute the limit control itself.

Although the embodiments of the present invention have been described above with reference to the drawings, it is needless to say that the present invention is not limited to the embodiments described above. It is apparent to those skilled in the art that various changes or modifications can be conceived within the scope described in the claims, and it is understood that the changes or modifications naturally fall within the technical scope of the present invention. In addition, the constituent elements in the embodiments described above may be freely combined without departing from the gist of the invention.

In the embodiments described above, an example in which the vehicle control system of the present invention is implemented by the control system CTR including the electronic control unit ECU mounted on the motorcycle 1 has been described, but the present invention is not limited thereto. For example, some or all of functions of the electronic control unit ECU described above may be implemented by another computer (for example, a server) capable of communicating with the electronic control unit ECU. In addition, some or all of the functions of the electronic control unit ECU described above may be implemented by cooperation of the electronic control unit ECU and another computer capable of communicating with the electronic control unit ECU, and for example, some of the processing performed by the electronic control unit ECU described above may be performed by the other computer.

A control method described in the embodiments described above can be implemented by executing a program prepared in advance by a computer (in other words, a processor). The program (control program) is stored in a computer-readable storage medium and is executed by being read from the storage medium. In addition, the program may be provided in a form of being stored in a nonvolatile (non-transitory) storage medium such as a flash memory, or may be provided via a network such as the Internet. The computer that executes the program may be included in a saddle-type vehicle such as the motorcycle 1, or may be included in an external device (for example, a server) that is capable of communicating with the saddle-type vehicle.

In the present description and the like, at least the following matters are described. Although corresponding constituent elements in the embodiments described above are shown in parentheses, the present invention is not limited thereto.

(1) A vehicle control system (electronic control unit ECU, pressurization modulator 65, control system CTR) for controlling a saddle-type vehicle (motorcycle 1), the saddle-type vehicle including a vehicle body frame (vehicle body frame 10), a steering device (steering unit 50) steerably supported by the vehicle body frame, a front wheel (front wheel FW) as a steering wheel rotatably supported by the steering device, a braking device (brake unit 61) configured to brake the front wheel according to a braking operation of an occupant, a first sensor (inertial measurement unit IMU) configured to detect a roll angle or a roll angular velocity of the vehicle body frame, and a second sensor (brake hydraulic pressure sensor Se2) configured to detect a predetermined parameter related to a braking force of the braking device,
the vehicle control system
being capable of controlling the braking force of the braking device, and
executing limit control for limiting a decrease in the braking force when it is determined that the vehicle body frame is to be changed to or is changed to an inclined state based on the roll angle or the roll angular velocity detected by the first sensor and it is determined that the braking force decreases based on the parameter detected by the second sensor.

According to (1), even if an operation of suddenly decreasing the braking force of the braking device is performed when the vehicle body frame (that is, the saddle-type vehicle) is to be changed to or is changed to the inclined state, the decrease in the braking force can be limited. Accordingly, a vertical load of the front wheel which is the steering wheel can be secured, and thus it is possible to limit a sudden change in a steering torque of the steering device in the saddle-type vehicle and to stabilize steering of the occupant. Therefore, it is possible to improve operability of the saddle-type vehicle, thereby further improving safety of traffic and contributing to development of a sustainable transportation system.

(2) The vehicle control system according to (1), in which
the braking device is a hydraulic braking device configured to brake the front wheel by a brake hydraulic pressure,
the second sensor is configured to detect the brake hydraulic pressure as the parameter, and
the vehicle control system
is capable of controlling the braking force by controlling the brake hydraulic pressure.
determines that the braking force decreases and executes the limit control when a hydraulic pressure change rate, which is a change amount in the brake hydraulic pressure per unit time, is larger than a predetermined threshold or when the brake hydraulic pressure is smaller than a predetermined threshold, and
controls the brake hydraulic pressure to limit the decrease in the braking force in the limit control.

When the braking force of the front wheel by the braking device decreases, the vertical load of the front wheel decreases, and the steering torque decreases. According to (2), by the limit control, the brake hydraulic pressure is controlled to limit the decrease in the braking force by the braking device, so that the vertical load of the front wheel can be secured, and thus it is possible to limit the sudden change in the steering torque of the steering device in the saddle-type vehicle, stabilize the steering of the occupant, and improve the operability of the saddle-type vehicle. In addition, according to (2), by utilizing the hydraulic braking device capable of braking the front wheel, it is possible to limit the sudden change in the steering torque in the saddle-type vehicle and to stabilize the steering of the occupant. That is, by indirectly controlling the steering torque via the braking force by such a braking device, it is possible to control the steering torque without providing, in the saddle-type vehicle, a motor or the like for directly controlling the steering torque. Accordingly, it is possible to limit the sudden change in the steering torque in the saddle-type vehicle and stabilize the steering of the occupant while limiting a configuration of the saddle-type vehicle from becoming complicated.

(3) The vehicle control system according to (2), in which
the saddle-type vehicle further includes a steering torque sensor (steering torque sensor Se1) configured to detect a steering torque for the steering device, and
in the limit control, the vehicle control system controls the brake hydraulic pressure such that the steering torque detected by the steering torque sensor is a predetermined target value corresponding to the roll angular velocity.

According to (3), an appropriate steering torque corresponding to the roll angular velocity can be obtained, and thus the steering of the occupant can be stabilized. For example, when the steering torque is smaller than the target value corresponding to the roll angular velocity at that time, it is possible to increase the steering torque to the target value. Accordingly, the saddle-type vehicle is limited from falling down with a small force, and the steering of the occupant can be stabilized.

(4) The vehicle control system according to (2), in which
in the limit control, the vehicle control system controls the brake hydraulic pressure such that the hydraulic pressure change rate decreases as the hydraulic pressure change rate increases.

According to (4), it is possible to appropriately control the brake hydraulic pressure according to the hydraulic pressure change rate when an operation of decreasing the braking force of the braking device is performed. Accordingly, for example, in a case where the hydraulic pressure change rate when the operation of decreasing the braking force of the braking device is performed is relatively large, the brake hydraulic pressure is controlled such that the hydraulic pressure change rate decreases, the braking force of the braking device and the steering torque in the saddle-type vehicle are limited from suddenly changing, and the steering of the occupant can be stabilized. On the other hand, in a case where the hydraulic pressure change rate when the operation of decreasing the braking force of the braking device is performed is relatively small, it is possible to limit the brake hydraulic pressure from being excessively controlled and to prevent the occupant from feeling discomfort or displeasure due to excessive control intervention.

(5) The vehicle control system according to (4), in which
the vehicle control system is capable of estimating a vertical load of the front wheel, and
in the limit control, the vehicle control system further controls the brake hydraulic pressure such that the hydraulic pressure change rate decreases as a change amount in an estimated vertical load of the front wheel increases.

According to (5), it is possible to appropriately control the brake hydraulic pressure according to the change amount of the vertical load of the front wheel due to the operation of decreasing the braking force of the braking device. Accordingly, for example, when the change amount of the vertical load of the front wheel due to the operation of decreasing the braking force of the braking device is relatively large, the brake hydraulic pressure is controlled such that the hydraulic pressure change rate decreases, the braking force of the braking device and the steering torque in the saddle-type vehicle are limited from suddenly changing, and the steering of the occupant can be stabilized. On the other hand, when the change amount of the vertical load of the front wheel due to the operation of decreasing the braking force of the braking device is relatively small, it is possible to limit the brake hydraulic pressure from being excessively controlled and to prevent the occupant from feeling discomfort or displeasure due to excessive control intervention.

(6) The vehicle control system according to (4), in which
in the limit control, the vehicle control system further controls the brake hydraulic pressure such that the hydraulic pressure change rate decreases as the roll angular velocity increases.

According to (6), it is possible to appropriately control the brake hydraulic pressure according to the roll angular velocity when the operation of decreasing the braking force of the braking device is performed. Accordingly, for example, in a case where the roll angular velocity when the operation of decreasing the braking force of the braking device is performed is relatively large, the brake hydraulic pressure is controlled such that the hydraulic pressure change rate decreases, the braking force of the braking device and the steering torque in the saddle-type vehicle are limited from suddenly changing, and the steering of the occupant can be stabilized. On the other hand, in a case where the roll angular velocity when the operation of decreasing the braking force of the braking device is performed is relatively small, it is possible to limit the brake hydraulic pressure from being excessively controlled and to prevent the occupant from feeling discomfort or displeasure due to excessive control intervention.

(7) The vehicle control system according to any one of (3) to (6), in which
the saddle-type vehicle further includes a vehicle speed sensor (vehicle speed sensor Se3) configured to detect a vehicle speed that is a travel speed of the saddle-type vehicle, and
when the roll angle is equal to or smaller than a first predetermined value and the vehicle speed is equal to or smaller than a second predetermined value, the vehicle control system does not execute the limit control or reduces limit of the braking force by the limit control as compared with a case where the roll angle is larger than the first predetermined value or the vehicle speed is larger than the second predetermined value.

When both the roll angle and the vehicle speed are small to some extent, it can be regarded as substantially the same as straight traveling (for example, lane change), and thus it is assumed that the occupant can steer the saddle-type vehicle with a sufficient margin. According to (7), in such a case, by not executing the limit control or reducing the limit of the braking force by the limit control, it is possible to limit the brake hydraulic pressure from being excessively controlled and to prevent the occupant from feeling discomfort or displeasure due to excessive control intervention.

(8) The vehicle control system according to any one of (3) to (7), in which
the saddle-type vehicle further includes a vehicle speed sensor (vehicle speed sensor Se3) configured to detect a vehicle speed that is a travel speed of the saddle-type vehicle, and
when the roll angle is larger than a third predetermined value and the vehicle speed is larger than a fourth predetermined value, the vehicle control system does not execute the limit control or reduces limit of the braking force by the limit control as compared with a case where the roll angle is equal to or smaller than the third predetermined value or the vehicle speed is equal to or smaller than the fourth predetermined value.

When both the roll angle and the vehicle speed are large to some extent, it is assumed that the steering torque is secured to some extent by an inertial force of the front wheel. Therefore, according to (8), in such a case, by not executing the limit control or reducing the limit of the braking force by the limit control, it is possible to limit the brake hydraulic pressure from being excessively controlled and to prevent the occupant from feeling discomfort or displeasure due to excessive control intervention. In addition, when both the roll angle and the vehicle speed are large to some extent, there is a possibility that the occupant has high skill or the saddle-type vehicle is traveling on a circuit. According to (8), in such a case, by not executing the limit control or reducing the limit of the braking force by the limit control, it is possible to limit the brake hydraulic pressure from being excessively controlled and to prevent the occupant from feeling discomfort or displeasure due to excessive control intervention.

(9) A saddle-type vehicle (motorcycle 1) including:
a vehicle body frame (vehicle body frame 10);
a steering device (steering unit 50) steerably supported by the vehicle body frame;
a front wheel (front wheel FW) as a steering wheel rotatably supported by the steering device;
a braking device (brake unit 61) configured to brake the front wheel according to a braking operation of an occupant;
a first sensor (inertial measurement unit IMU) configured to detect a roll angle or a roll angular velocity of the vehicle body frame;
a second sensor (brake hydraulic pressure sensor Se2) configured to detect a predetermined parameter related to a braking force of the braking device, and
a vehicle control system (electronic control unit ECU, pressurization modulator 65, control system CTR), in which
the vehicle control system
is configured to control the braking force of the braking device, and
executes limit control for limiting a decrease in the braking force when it is determined that the vehicle body frame is to be changed to or is changed to an inclined state based on the roll angle or the roll angular velocity detected by the first sensor and it is determined that the braking force decreases based on the parameter detected by the second sensor.

According to (9), even if an operation of suddenly decreasing the braking force of the braking device is performed when the vehicle body frame (that is, the saddle-type vehicle) is to be changed to or is changed to the inclined state, the decrease in the braking force can be limited. Accordingly, a vertical load of the front wheel which is the steering wheel can be secured, and thus it is possible to limit a sudden change in a steering torque of the steering device in the saddle-type vehicle and to stabilize steering of the occupant. Therefore, it is possible to improve operability of the saddle-type vehicle, thereby further improving safety of traffic and contributing to development of a sustainable transportation system.

The present application is based on a Japanese Patent Application (Japanese Patent Application No. 2023-057242) filed on Mar. 31, 2023, and the contents thereof are incorporated herein by reference.

### REFERENCE SIGNS LIST

1: motorcycle (saddle-type vehicle)
10: vehicle body frame
50: steering unit (steering device)
61: brake unit (braking device)
CTR: control system (vehicle control system)
ECU: electronic control unit (vehicle control system)
65: pressurization modulator (vehicle control system)
FW: front wheel
IMU: inertial measurement unit (first sensor)
RD: rider (occupant)
Se1: steering torque sensor
Se2: brake hydraulic pressure sensor (second sensor)
Se3: vehicle speed sensor

1. A vehicle control system for controlling a saddle-type vehicle, the saddle-type vehicle including a vehicle body frame, a steering device steerably supported by the vehicle body frame, a front wheel as a steering wheel rotatably supported by the steering device, a braking device configured to brake the front wheel according to a braking operation of an occupant, a first sensor configured to detect a roll angle or a roll angular velocity of the vehicle body frame, and a second sensor configured to detect a predetermined parameter related to a braking force of the braking device,
the vehicle control system
being capable of controlling the braking force of the braking device, and
executing limit control for limiting a decrease in the braking force when it is determined that the vehicle body frame is to be changed to or is changed to an inclined state based on the roll angle or the roll angular velocity detected by the first sensor and it is determined that the braking force decreases based on the parameter detected by the second sensor.

2. The vehicle control system according to claim 1, wherein
the braking device is a hydraulic braking device configured to brake the front wheel by a brake hydraulic pressure,
the second sensor is configured to detect the brake hydraulic pressure as the parameter, and
the vehicle control system
is capable of controlling the braking force by controlling the brake hydraulic pressure,
determines that the braking force decreases and executes the limit control when a hydraulic pressure change rate, which is a change amount in the brake hydraulic pressure per unit time, is larger than a predetermined threshold or when the brake hydraulic pressure is smaller than a predetermined threshold, and
controls the brake hydraulic pressure to limit the decrease in the braking force in the limit control.

3. The vehicle control system according to claim 2, wherein
the saddle-type vehicle further includes a steering torque sensor configured to detect a steering torque for the steering device, and
in the limit control, the vehicle control system controls the brake hydraulic pressure such that the steering torque detected by the steering torque sensor is a predetermined target value corresponding to the roll angular velocity.

4. The vehicle control system according to claim 2, wherein
in the limit control, the vehicle control system controls the brake hydraulic pressure such that the hydraulic pressure change rate decreases as the hydraulic pressure change rate increases.

5. The vehicle control system according to claim 4, wherein
the vehicle control system is capable of estimating a vertical load of the front wheel, and
in the limit control, the vehicle control system further controls the brake hydraulic pressure such that the hydraulic pressure change rate decreases as a change amount in an estimated vertical load of the front wheel increases.

6. The vehicle control system according to claim 4, wherein
in the limit control, the vehicle control system further controls the brake hydraulic pressure such that the hydraulic pressure change rate decreases as the roll angular velocity increases.

7. The vehicle control system according to claim 3, wherein
the saddle-type vehicle further includes a vehicle speed sensor configured to detect a vehicle speed that is a travel speed of the saddle-type vehicle, and
when the roll angle is equal to or smaller than a first predetermined value and the vehicle speed is equal to or smaller than a second predetermined value, the vehicle control system does not execute the limit control or reduces limit of the braking force by the limit control as compared with a case where the roll angle is larger than the first predetermined value or the vehicle speed is larger than the second predetermined value.

8. The vehicle control system according to any claim 3, wherein
the saddle-type vehicle further includes a vehicle speed sensor configured to detect a vehicle speed that is a travel speed of the saddle-type vehicle, and
when the roll angle is larger than a third predetermined value and the vehicle speed is larger than a fourth predetermined value, the vehicle control system does not execute the limit control or reduces limit of the braking force by the limit control as compared with a case where the roll angle is equal to or smaller than the third predetermined value or the vehicle speed is equal to or smaller than the fourth predetermined value.

9. A saddle-type vehicle comprising:
a vehicle body frame;
a steering device steerably supported by the vehicle body frame;
a front wheel as a steering wheel rotatably supported by the steering device;
a braking device configured to brake the front wheel according to a braking operation of an occupant;
a first sensor configured to detect a roll angle or a roll angular velocity of the vehicle body frame;
a second sensor configured to detect a predetermined parameter related to a braking force of the braking device; and
a vehicle control system, wherein
the vehicle control system
is configured to control the braking force of the braking device, and
executes limit control for limiting a decrease in the braking force when it is determined that the vehicle body frame is to be changed to or is changed to an inclined state based on the roll angle or the roll angular velocity detected by the first sensor and it is determined that the braking force decreases based on the parameter detected by the second sensor.
